(19) United States
(12) Patent Application Publication
(10) Pub. No.: US 2025/0343584 A1
(43) Pub. Date: Nov. 6, 2025

(54) SIGNALING FOR UE INITIATED BEAM REPORTING

(71) Applicant: Samsung Electronics Co., Ltd., Suwon-si (KR)

(72) Inventors: Shiyang Leng, Little Elm, TX (US); Anil Agiwal, Allen, TX (US); Kyeongin Jeong, Allen, TX (US)

(21) Appl. No.: 19/192,083

(22) Filed: Apr. 28, 2025

Related U.S. Application Data
(60) Provisional application No. 63/642,046, filed on May 3, 2024.
(60) Provisional application No. 63/670,589, filed on Jul. 12, 2024.
(60) Provisional application No. 63/693,018, filed on Sep. 10, 2024.
(60) Provisional application No. 63/778,965, filed on Mar. 27, 2025.

(51) Int. Cl. H04B 7/06; H04B 17/318; H04W 24/10; H04W 72/21; H04W 76/28

(52) U.S. Cl. CPC H04B 7/0626; H04B 17/328; H04W 24/10; H04W 72/21; H04W 76/28

(57) ABSTRACT

A user equipment (UE) capable of facilitating communications in a wireless system can include a transceiver and a processor. In some examples, the transceiver is to receive a UE initiated channel state information (CSI) reporting configuration indicating one or more resources for CSI measurements and a condition to evaluate. The processor can perform a CSI measurement on the one or more resources, determine the condition is satisfied, and initiate a UE initiated CSI report. The transceiver transmits the notification of the UE initiated CSI report. The transceiver receives, from the BS, a downlink control information (DCI) indicating a CSI trigger state associated with the UE initiated CSI report, the DCI indicating a physical uplink shared channel (PUSCH) resource for the UE initiated CSI reporting and transmits the UE initiated CSI reporting in the PUSCH resource indicated by the DCI.

### CROSS-REFERENCE TO RELATED APPLICATIONS

This application claims the benefit of priority from U.S. Provisional Application No. 63/642,046 entitled “SIGNALING FOR UE INITIATED BEAM REPORTING,” filed May 3, 2024; U.S. Provisional Application No. 63/670,589 entitled “SIGNALING FOR UE INITIATED BEAM REPORTING,” filed Jul. 12, 2024; U.S. Provisional Application No. 63/693,018 entitled “UE INITIATED BEAM REPORTING BY UPLINK CONTROL INFORMATION,” filed Sep. 10, 2024; and U.S. Provisional Application No. 63/778,965 entitled “UE INITIATED BEAM REPORTING BY UPLINK CONTROL INFORMATION,” filed Mar. 27, 2025, all which are incorporated herein by reference in their entirety.

### TECHNICAL FIELD

This disclosure relates generally to a wireless communication system, and more particularly to, for example, but not limited to, user equipment (UE) signaling for UE initiated beam reporting in a wireless communication system.

### BACKGROUND

Beam management represents a pivotal aspect of any high-speed wireless communication system. These systems include, for example, LTE and 5G New Radio (NR), and upcoming technologies currently coined “6G”. These systems can transmit signals at high frequencies, forming beams as a result. In order to determine a direction and intensity to direct the beam to service user equipment (UE), a base station (BS) or 5G node (e.g., gNB) can utilize beam management procedures. This can include the BS transmitting one or more beams at the UE to detect a best beam to service the UE with.

In legacy beam management procedures, the network (e.g., base station or gNB) can configure or activate frequent or semi-persistent beam reporting—e.g., determine N best beams and their corresponding layer one (e.g., L1, a physical layer) reference signal received power (RSRP). In other examples, the network can trigger frequent aperiodic beam reporting to timely acquire the best/preferred beams for data/control transmissions. However, having the network configure or activate frequent, semi-persistent, or aperiodic beam reporting can cause significant uplink (UL) reporting overhead and control signaling overhead. If less frequent beam reporting is used or configured though, the network may be unable to acquire the best/preferred beams for data/control transmissions. That is, infrequent reporting can lead to the network acquiring beam reporting information from the UE that is outdated and cause performance degradation.

In some systems, because the UE is better positioned to determine changes in beam quality, UE initiated beam reporting procedures can be used. This can lead to more timely beam reports without the overhead cost associated with the network transmitting the requests. Under UE initiated beam reporting, the UE can determine that a current beam quality is poor, trigger beam reporting, and report the results to the network without a need to configure or trigger frequent reporting. In some cases, there is a need to enhance the legacy CSI measurements and reporting procedures to facilitate the UE initiated beam reporting as described herein.

The description set forth in the background section should not be assumed to be prior art merely because it is set forth in the background section. The background section may describe aspects or embodiments of the present disclosure.

### SUMMARY

An aspect of the present disclosure provides for a user equipment (UE) for facilitating communication in a wireless network, the UE including a transceiver configured to cause receiving, from a base station (BS), a UE initiated channel state information (CSI) reporting configuration, the UE initiated CSI reporting configuration indicating one or more resources for CSI measurement and a condition to evaluate associated with the one or more resources; a processor operably coupled to the transceiver, the processor configured to cause performing a CSI measurement on the one or more resources indicated by the UE initiated CSI reporting configuration; determine the condition indicated in the UE initiated CSI reporting configuration is satisfied; initiate a UE initiated CSI report when the condition is satisfied, wherein the transceiver is further configured to cause transmitting, to the BS, a notification of the UE initiated CSI report; receive, from the BS, a downlink control information (DCI) indicating a CSI trigger state associated with the UE initiated CSI report, the DCI indicating a physical uplink shared channel (PUSCH) resource for the UE initiated CSI reporting; and transmit, to the BS, the UE initiated CSI report in the PUSCH resource indicated by the DCI.

In an embodiment, the processor is further to cause determining if a medium access control (MAC) entity associated with the UE monitors a physical downlink control channel (PDCCH) of a serving cell belonging to a discontinuous reception (DRX) group and wherein the transceiver is further to cause transmitting the UE initiated CSI report when the UE initiated CSI report is initiated whether the MAC entity monitors the PDCCH or the MAC entity refrains from monitoring the PDCCH.

In one or more embodiments, the UE initiated CSI reporting configuration includes a report type indicating a mode of the UE initiated CSI report.

In some embodiments, each of the one or more resources for the CSI measurements is identified by a respective CSI resource ID.

In at least one embodiment, the one or more resources for the CSI measurements indicate one or more reference signals, the one or more reference signals including a synchronization signal block (SSB) signal or a CSI-reference signal (RS).

In some embodiments, the UE initiated CSI reporting configuration includes one or more resources for CSI reporting including a physical uplink control channel (PUCCH) resource identification (ID) to identify one or more PUCCH resources to use to transmit the notification.

In one embodiment, the UE initiated CSI reporting configuration includes one or more resources for CSI reporting including a PUSCH resource identification (ID) to identify one or more PUSCH resources to use to transmit the UE initiated CSI report.

In at least one or more embodiments, the UE initiated CSI reporting configuration includes a report quantity indicating a quantity to measure or report for the UE initiated CSI report.

In some cases, the UE initiated CSI reporting configuration includes one or more parameters for the condition, the parameters including one or more thresholds for reference signal received power (RSRP), reference signal received quality (RSRQ), or a signal-to-interference-plus-noise-ratio (SINR).

In some embodiments, the UE initiated CSI reporting configuration includes one or more event identifications (IDs), and wherein the processor is further configured to evaluate the condition of an event ID of the one or more event IDs using the one or more resources for the CSI measurement and determine the condition of the event ID is satisfied, wherein the determining the condition of the CSI measurement is satisfied is based on determining the condition of the event ID is satisfied.

An aspect of the present disclosure provides for a method performed by a user equipment (UE) for facilitating communication in a wireless network, including: receiving, from a base station (BS), a UE initiated channel state information (CSI) reporting configuration, the UE initiated CSI reporting configuration indicating one or more resources for CSI measurement and a condition to evaluate associated with the one or more resources; performing a CSI measurement on the one or more resources indicated by the UE initiated CSI reporting configuration; determining the condition indicated in the UE initiated CSI reporting configuration is satisfied; initiating a UE initiated CSI report when the condition is satisfied; transmitting, to the BS, a notification of the UE initiated CSI report; receiving, from the BS, a downlink control information (DCI) indicating a CSI trigger state associated with the UE initiated CSI report, the DCI indicating a physical uplink shared channel (PUSCH) resource for the UE initiated CSI reporting; and transmitting, to the BS, the UE initiated CSI report in the PUSCH resource indicated by the DCI.

In an embodiment, the method further includes determining if a medium access control (MAC) entity associated with the UE monitors a physical downlink control channel (PDCCH) of a serving cell belonging to a discontinuous reception (DRX) group; and transmitting the UE initiated CSI report when the UE initiated CSI report is initiated whether the MAC entity monitors the PDCCH or the MAC entity refrains from monitoring the PDCCH.

In some embodiments, the UE initiated CSI reporting configuration includes a report type indicating a mode of the UE initiated CSI report.

In at least one embodiment, each of the one or more resources for the CSI measurements is identified by a respective CSI resource ID.

In one or more embodiments, the one or more resources for the CSI measurements indicate one or more reference signals, the one or more reference signals including a synchronization signal block (SSB) signal or a CSI-reference signal (RS).

In at least one embodiment, the UE initiated CSI reporting configuration includes one or more resources for CSI reporting including a PUSCH resource identification (ID) to identify one or more PUSCH resources to use to transmit the UE initiated CSI report.

In some examples, the UE initiated CSI reporting configuration includes one or more parameters for the condition, the parameters including one or more thresholds for reference signal received power (RSRP), reference signal received quality (RSRQ), or a signal-to-interference-plus-noise-ratio (SINR).

An aspect of the present disclosure provides for a base station (BS) for facilitating communication in a wireless network, the BS including a transceiver configured to cause transmit, to a user equipment (UE), a UE initiated channel state information (CSI) reporting configuration, the UE initiated CSI reporting configuration indicating one or more resources for CSI measurement and a condition to evaluate associated with the one or more resource; receive, from the UE, a notification of a UE initiated CSI report; transmit, to the UE, a downlink control information (DCI) indicating a CSI trigger state associated with the UE initiated CSI report, the DCI indicating a physical uplink shared channel (PUSCH) resource for the UE initiated CSI reporting; and receive, from the UE, the UE initiated CSI report in the PUSCH resource indicated by the DCI.

In some embodiments, the UE initiated CSI reporting configuration includes one or more parameters for the condition, the parameters including one or more thresholds for reference signal received power (RSRP), reference signal received quality (RSRQ), or a signal-to-interference-plus-noise-ratio (SINR).

In at least one embodiment, the one or more resources for the CSI measurements indicate one or more reference signals, the one or more reference signals including a synchronization signal block (SSB) signal or a CSI-reference signal (RS).

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example single-entry MAC CE 400 for utilizing UE initiated beam reporting in accordance with an embodiment.

FIG. 5 shows an example multi-entry MAC CE 500 for utilizing UE initiated beam reporting in accordance with an embodiment in accordance with an embodiment.

FIG. 6 shows an example multi-entry MAC CE 600 for utilizing UE initiated beam reporting in accordance with an embodiment in accordance with an embodiment.

FIG. 7 shows an example process 700 for UE signaling for UE initiated beam reporting in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHZ, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

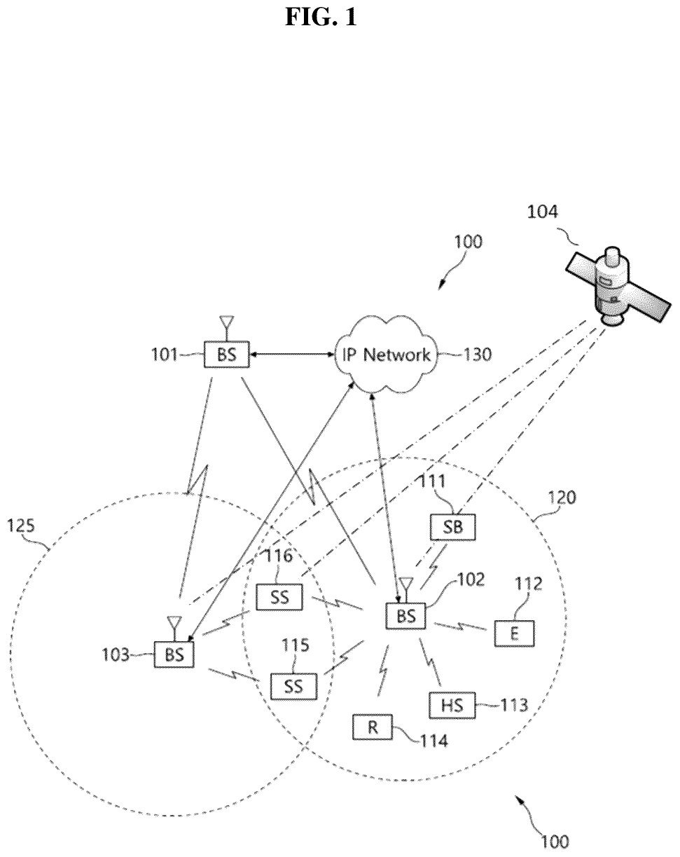

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs 102 and 103 can also be on board the communication satellite(s) 104. One or more of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for supporting mobility in wireless networks. In certain embodiments, one or more of the BSs 101-103 include circuitry, programing, or a combination thereof to mobility in wireless networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

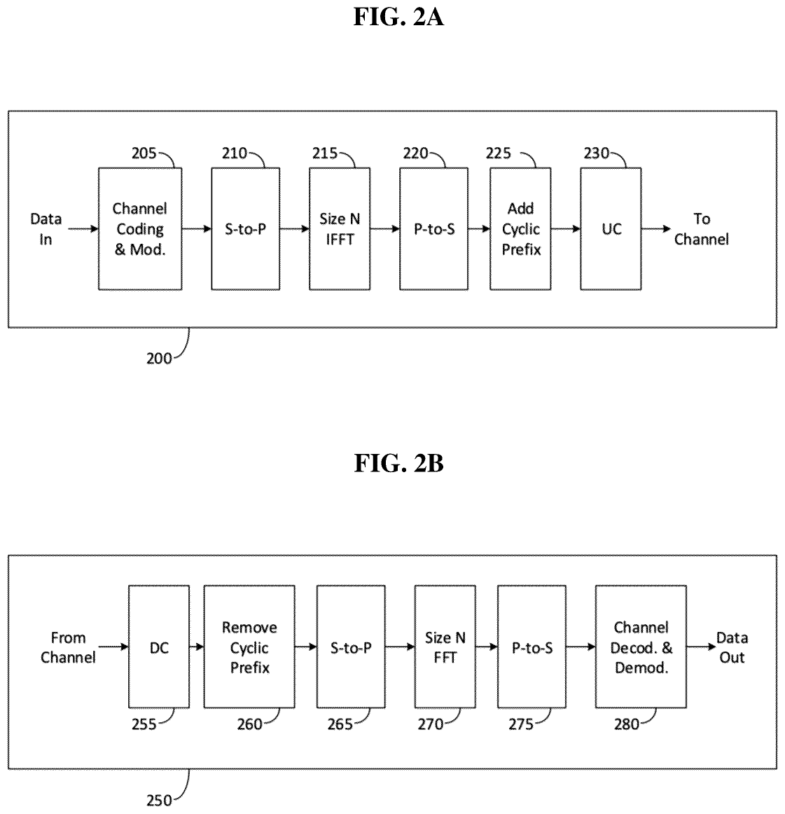

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible. In some embodiments, the transmit path 200A and the receive path 200B is configured to support mobility in wireless networks as described in various embodiments of the present disclosure.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1). The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory (ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

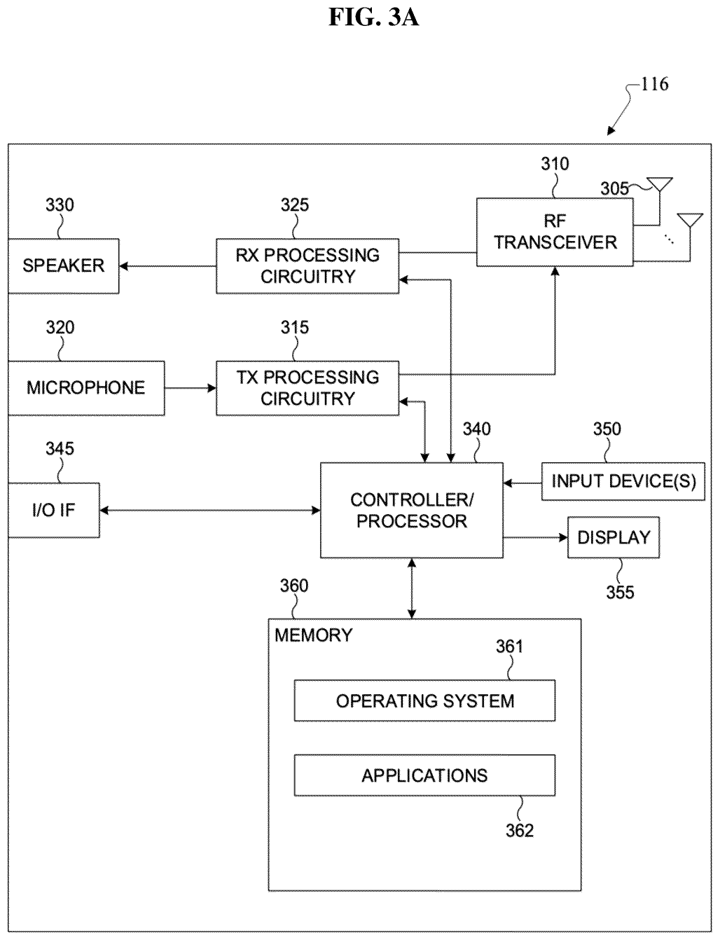

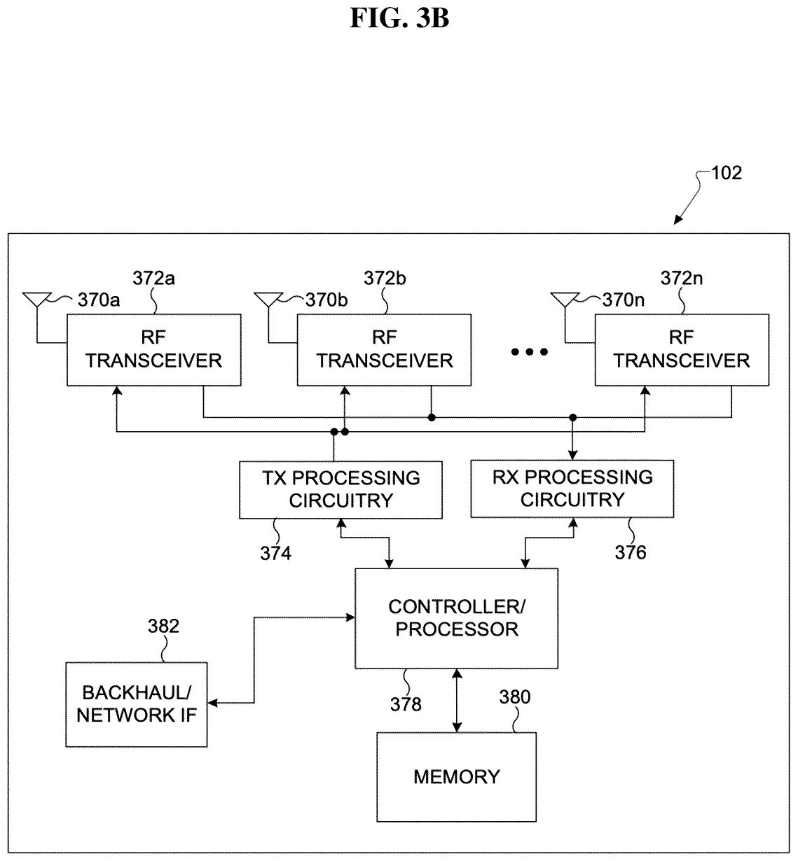

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 coupled to the processor 340, directly or through intervening elements. The main processor 340 is also capable of executing other processes and programs resident in the memory 360, such as CLTM in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. For example, the main processor 340 may execute processes to support mobility in wireless networks as described in various embodiments of the present disclosure. The main processor 340 is also coupled to the I/O interface 345, which provides the UE 300A with the ability to connect to other devices such as laptop computers and handheld computers. The I/O interface 345 is the communication path between these accessories and the main controller 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. As another example, the processor 378 could support mobility in wireless networks. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting CLTM in wireless communication systems as described in embodiments of the present disclosure. In some embodiments, the controller/processor 378 supports communications between entities, such as web RTC. The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one transmission or receive per RF transceiver).

As an example, Release 13 of the LTE standard supports up to 16 CSI-RS [channel status information—reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms (e.g., CLTM, etc.) may be formulated by the inventors and designed to assist in providing an efficient description of the unique features within the disclosure.

The following documents are hereby incorporated by reference in their entirety into the present disclosure as if fully set forth herein: i) 3GPP TS 38.300 v18.1.0; ii) 3GPP TS 38.331 v18.1.0; and iii) 3GPP TS 38.321 v18.1.0.

3GPP (Third-Generation Partnership Project) has developed technical specifications and standards to define the new 5G radio-access technology, known as 5G NR (new radio). In some embodiments, legacy beam management procedures, a network (e.g., base station, or gNB) can configure or activate periodic or semi-periodic beam reporting—e.g., the network can initiate periodic channel state information (CSI) reference signal (RS) or initiate a semi-periodic CSI-RS report. In some embodiments, the periodic reporting has a same offset between each CSI-RS transmitted by the network. In some embodiments, the UE can determine an N best beam and a corresponding layer one (e.g., L1 or a physical layer) reference signal received power (RSRPs). In some embodiments, the network can trigger frequent aperiodic beam reporting to timely acquire a best or preferred beam for transmitting data/control information—e.g., initiate aperiodic CSI-RS via a downlink control information (DCI) or a medium access control (MAC) control element (CE). In at least some embodiments though, having the network initiate the periodic or semi-periodic reporting or trigger the aperiodic reporting can cause large uplink (UL) reporting overhead and control signaling overhead. In other embodiments, if the network performs less frequent beam reporting procedures, the beam reporting by the UE can be outdated and cause performance degradation—e.g., by not frequently determining the beam reporting of the UE, the network can fail to accurately determine current beam information for the UE. Accordingly, it may be desirable to have UE initiated beam reporting. That is, the UE can have better and more-timely knowledge of changes in beam quality. In such embodiments, UE initiated beam reporting can lead to accurate beam information being collected while reducing the network overhead. In some embodiments, the UE can determine a current beam quality becomes poor (e.g., drops below a threshold quality) and trigger a beam reporting without the network configuring the UE or triggering frequent reporting.

In at least one embodiment, for UE initiated beam reporting, the UE can first receive a configuration of a UE initiated beam reporting from the base station (BS). In at least one embodiment, the BS can transmit the configuration to include information on events, reference signals (RS) to be measured, report content, and/or resources allocated for reporting. In such embodiments, the UE can begin to evaluate events indicated by the configuration by measuring the indicated and configured RS(s). In some embodiments, the UE can determine a certain event is fulfilled e.g., the UE can measure the RS(s) and determine an event indicated by the configuration is fulfilled. In at least one embodiment, the UE can initiate a report procedure and transmit the beam report as a uplink control information (UCI) to the BS.

In at least one embodiment, for the UE initiated beam report procedure, the UE can first transmit a notification to the BS as a one-bit flag in the UCI or the UE can transmit a scheduling request (SR). In at least one embodiment, the UE can receive a dynamic grant indicated in a DCI for the UE initiated beam reporting. In such embodiments, the UE can proceed with transmitting the beam report as UCI in the provided dynamic grant. In some embodiments, this configuration can be referred to as mode A or a first mode.

In some other embodiments, for the UE initiated beam report procedure, UE can first transmit the notification to the BS as the one-bit flag in UCI or the UE can transmit the SR. In at least one embodiment, the UE can transmit the report as UCI in a configured uplink (UL) grant provided in the UE initiated beam reporting configuration. In some embodiments, this configuration can be referred to as mode B or a second mode.

In some embodiments, UE signaling and procedure for a UE initiated (e.g., or event driven) beam reporting is described herein. In at least one embodiment, the UE initiated beam reporting can facilitate fast beam switching. In at least one embodiment, a UE initiated beam report can refer to or be considered the same as a UE initiated CSI reporting, a UE initiated beam reporting, an event-driven beam/CSI reporting, UE based CSI/beam reporting, or UE beam reporting. Additionally, the UE initiated reporting and event-driven/triggered reporting are used interchangeably. In at least one embodiment, the UE initiated reporting can be used for beam management and/or for layer one (L1) measurement based mobility—e.g., the UE initiated beam reporting can be used for L1/L2 (e.g., layer two or a data link layer) triggered mobility. That is, the UE can use the UE initiated reporting for a lower layer triggered mobility (LTM) or conditional LTM.

For example, in some embodiments, the UE can receive a UE initiated CSI reporting configuration from the network (e.g., BS or gNB). In some embodiments, the CSI reporting configuration is per bandwidth part (BWP) or per serving cell. In at least one embodiment, the CSI reporting configuration can include a new type of UE initiated/event trigger in a field of the CSI report—e.g., the UE initiated/event trigger can be included in a reportConfigType field of the CSI-ReportConfig parameter. In some embodiments, the UE initiated/event trigger can encompass one or more events—e.g., one or more events can be configured or indicated in the reportConfigType field. In some embodiments, each event can be characterized by an event identification (ID), one or more parameters (e.g., a threshold for RSRP, a threshold for reference signal received quality (RSRQ), a threshold for signal-to interference-plus-noise-ratio (SINR), etc.), associated report quantities, resources for CSI measurement (e.g., a reference signal including one or more multiple Synchronization Signal Blocks (SSB(s)) or a CSI-RS), and/or physical uplink control channel (PUCCH)/physical uplink shared channel (PUSCH) resources for reporting (e.g., a PUCCH/PUSCH resource set identification (ID) indicating which PUCCH/PUSCH resources to utilize).

In at least one embodiment, the UE initiated beam reporting can be activated explicitly or implicitly. For example, when the UE initiated beam reporting is activated explicitly, the UE can receive an indication in a radio resource control (RRC) message, a MAC CE, or in DCI. In one example, a one-bit indicator (e.g., one-bit flag) is utilized to indicate the UE initiated beam reporting in RRC signaling. In some embodiments, after the UE receives the indicator, the UE can perform a aperiodic or periodic CSI report based on the received UE initiated CSI reporting configuration. For example, the UE can perform the UE initiated CSI reporting by using all or a subset of the CSI resources that are reserved for aperiodic CSI reporting in the UE initiated CSI reporting configuration. That is, the UE initiated CSI reporting includes CSI measurement resources and the UE can utilize the resources indicated to perform aperiodic CSI reporting. In other embodiments, the UE can perform the UE initiated CSI reporting by using all or a subset of the CSI resources that are reserved for periodic CSI reporting in the UE initiated CSI reporting configuration—e.g., the UE can perform the periodic CSI reporting based on the configuration indicated in the UE initiated CSI reporting configuration.

In other examples, the UE initiated beam reporting can be implicitly activated. For example, the UE can receive one or more events indicated by an event ID in the MAC CE or in a DCI. In one example, an event can be fulfilled if a new or measured RS is better than a current RS by a RSRP threshold amount. In at least one embodiment, the current RS can be the RS associated with a current transmission configuration indicator (TCI) state for a PUCCH/PUSCH transmission. In other embodiments, the current RS can be an RS indicated in a radio resource control (RRC) message, MAC CE, or DCI received by the UE from the network. In at least one embodiment, the UE can measure based on the configured resources indicated for the event—e.g., the UE can use RSs including SSBs and/or CSI-RSs based on resources for measuring CSI indicated in the UE initiated CSI reporting configuration. In one or more embodiments, the UE can evaluate a condition of the event (e.g., determine if the event is satisfied or fulfilled) and report the measurement results to the network when the condition is met—e.g., when the event is fulfilled.

In some embodiments, the configured resources for CSI measurements (e.g., the indication to use SSBs, CSI-RS, etc.) is indicated by a resource identification (ID) in a MAC CE or in a DCI. In some embodiments, one or multiple resources can be indicated, activated, or utilized. For example, the UE can use both SSBs and CSI-RS, use SSBs, or use CSI-RS. In some embodiments, the UE can measure the indicated resources to evaluate the indicated event. In some embodiments, based on the measurements of the CSI resources, the UE can determine the event is fulfilled and transmit the measurements results to the network.

In other embodiments, the UE can measure the indicated resources (e.g., RSs including the SSBs and the CSI-RSs) and evaluate a pre-define event. In such embodiments, the UE can report the measurement results to the network when the event is fulfilled. In some embodiments, the pre-defined event can be an example of a new or measured RS being better than a current RS by a RSRP threshold amount. In some embodiments, the current RS is an RS indicated by RRC, MAC CE, or DCI. In other embodiments, the current RS can be the RS associated with the current TCI state for a last PUCCH/PUSCH transmission. In some embodiments, one or more resources (e.g., RSs) that are already configured for aperiodic or periodic CSI measurements reports can also be used for the UE initiated beam reporting—e.g., SSBs or CSI-RS used for aperiodic or periodic reporting can also be used for UE initiated beam reporting.

In at least one embodiment, a codepoint of a DCI field “CSI request” can indicate an CSI report trigger state. For example, the codepoint of the DCI field “CSI request” can indicate one CSI report trigger state for a CSI report on RS(s) configured to be used for UE initiated beam reporting. In such embodiments, the UE measures the RS(s) for the UE initiated beam reporting and applies the associated aperiodic CSI report configuration indicated in the DCI.

In one embodiment, an event is indicated by the event ID in the MAC CE or in the DCI and a configured resource for CSI measurement (e.g., the SSBs or CSI-RSs) is indicated by a resource ID together in a corresponding MAC CE or DCI field. In such embodiments, one or multiple pairs of events and resources can be indicated or activated in the corresponding MAC CE or DCI field. In one embodiment, for an indicated pair of events and resources, the UE can measure the indicated resources, evaluate a condition of the indicated event, and report measurement results to the network when the condition of the event if fulfilled.

In one embodiment, for UE initiated beam reporting via a UCI, the UE may refrain from performing an uplink (UL) transmission skipping in a logical channel, even if skipping the UL transmission is configured for the UE. That is, the UE MAC entity can perform the following procedure (Procedure 1) to refrain from skipping UL transmissions:

```
1> if the MAC entity is configured with enhancedSkipUplinkTxDynamic with value true and
the grant indicated to the HARQ entity was addressed to a C-RNTI, or if the MAC entity is
configured with enhancedSkipUplinkTxDynamic with value true and the grant indicated
HARQ entity is a configured uplink grant:
  2> if there is no UCI to be multiplexed on this PUSCH transmission as specified in TS
  38.213[6]; and
  2> if there is no aperiodic CSI requested for this PUSCH transmission as specified in TS
  38.212[9]; and
  2> if there is no UE event-triggered/UE initiated beam reporting using UCI (e.g., in
  dynamic UL grant scheduled by DCI or in configured UL grant) for this PUSCH
  transmission as specified in TS 38.213/TS 38.214; and
  2> if the MAC PDU includes zero MAC SDUs; and
  2> if the MAC PDU includes only the periodic BSR and there is no data available for any
  LCG, or the MAC PDU includes only the padding BSR;
    3> not generate a MAC PDU for the HARQ entity.
1> else if the MAC entity is configured with skipUplinkTxDynamic with value true and the
grant indicated to the HARQ entity was addressed to a C-RNTI, or the grant indicated to the
HARQ entity is a configured uplink grant:
  2> if there is no aperiodic CSI requested for this PUSCH transmission as specified in TS
  38.212[9]; and
  2> if there is no UE event-triggered/UE initiated beam reporting using UCI (e.g., in
  dynamic UL grant scheduled by DCI or in configured UL grant) for this PUSCH
  transmission as specified in TS 38.213/TS 38.214; and
  2> if the MAC PDU includes zero MAC SDUs; and
  2> if the MAC PDU includes only the periodic BSR and there is no data available for any
  LCG, or the MAC PDU includes only the padding BSR;
    3> not generate a MAC PDU for the HARQ entity.
```

In at least one embodiment, enhancedSkipUplinkTxDynamic indicates whether the UE supports skipping UL transmissions for an uplink grant addressed to a cell-radio network temporary identifier (C-RNTI) only if no data is available for transmission and no UCI is multiplexed on the corresponding PUSCH of the uplink grant as specified in TS 38.321 [8]. In some embodiments, skipUplinkTxDynamic indicates whether the UE supports skipping of UL transmissions for an uplink grant indicated on a physical downlink control channel (PDCCH) if no data is available for transmission as specified in TS 38.321 [8]. In one embodiment, a HARQ entity is a hybrid automatic repeat request (HARQ) entity. In at least one embodiment, a MAC PDU is a medium access control protocol data unit. In some embodiments, a MAC SDU is a medium access control service data unit. In at least one embodiment, the BSR refers to a buffer status report. In some embodiments, LCG refers to a logical channel group.

In some embodiments, the UE initiated beam reporting can be configured via UCI. In such embodiments, the UE can transmit the reports using UCI in both an active time and inactive time of a UE dedicated discontinuous reception (DRX) cycle while in a connected mode (e.g., in a RRC connected mode). That is, regardless of whether the MAC entity is monitoring PDCCH or not on the serving cell in a DRX group, the MAC entity transmits the UE event-triggered/UE initiated beam reporting using UCI on PUSCH as specified in TS 38.213 or TS 38.214 on the serving cells in the DRX group. In at least one embodiment, the UE can use the UCI in a dynamic UL grant scheduled by DCI or in a configured UL grant.

In other embodiments, the UE initiated beam reporting can be configured via UCI. In such embodiments, the UE can transmit the report using UCI in both an active time and an inactive time of cell DRX cycles. In one embodiment, if the cell DRX is activated and the serving cell is not in the cell DRX active period, the UE reports event-triggered beam reporting using UCI (e.g. in a dynamic UL grant scheduled by DCI or in a configured UL grant) on PUSCH as specified in TS 38.213 or TS 38.214.

In some embodiments, for UE initiated beam reporting by UCI, the UE transmits the report using UCI on an active BWP if the active DL BWP for the serving cell is dormant. That is, for each activated serving cell configured with a BWP, if a BWP is activated and the active DL BWP for the serving cell is dormant, the UE refrains from reporting CSI on the BWP except aperiodic CSI or the UE event-triggered/UE event initiated beam reporting using UCI for the BWP—e.g., using the UCI in a dynamic UL grant scheduled by DCI or in a configured UL grant.

In at least one embodiment, the UE can be part of a asymmetric downlink (DL) single transmit and reception point (sTRP) and uplink (UL) multiple-transmit and reception points (mTRP)—e.g., the DL sTRP is asymmetric with the UL mTRP. In at least one embodiment, for dense UL-only TRPs, the UE can receive DL from a macro DL/UL TRP—e.g., from an anchor TRP. In such embodiments, the UE can transmit UL to micro UL-only TRPs. In at least one embodiment, there is a pathloss offset between a DL pathloss RS from the DL TRP and an actual pathloss for the UL-only TRP. In such embodiments, due to the pathloss offset, a UL power control to the UL-only TRPs is determined different than conventional power controls. That is, the UE UL power control uses the PL offset such that the UE reuses a legacy uplink power control formulation by replacing a legacy pathloss with a pathloss that is derived from the DL pathloss RS and the pathloss offset. In some embodiments, the pathloss offset is applied for PUCCH, PUSCH, SRS, PDCCH-order physical random access channel (PRACH) transmissions.

In some embodiments, for multi-TRP operations (e.g., up to two TRPs), multiple timing advances (TAs) (e.g., two TAs) can be used when transmitting to the respective multiple TRPs. In some embodiments, for multi-TRP operations, there are two mechanisms. For example, the first mechanism is a single DCI (sDCI) multi-TRP where transmissions from and to multi-TRPs are scheduled by a DCI from one TRP. In other embodiments, a second mechanism is a multi-DCI (mDCI) multi-TPR where transmission to and from the multi-TRPs is scheduled by DCI from multiple TRPs.

In at least one embodiment, the UE can distinguish between sDCI-mTRP-based 2TA operations and mDCI-mTRP-based 2 TA operations. In one embodiment, the UE can distinguish between the two by using a new RRC parameter that explicitly enables the sDCI-mTRP-based 2TA operations. That is, because the 2 TA configuration is configured per each serving cell and the sDCI/mDCI operations are configured per BWP, the new RRC parameters is defined per BWP to enable sDCI-mTRP-based 2TA operations or mDCI-mTRP-based 2TA operations for a respective BWP. In such embodiments, the UE can perform the mDCI-mTRP-based 2Ta operations or sDCI-mTRP-based 2TA operations based on the RRC parameter received.

In other embodiments, the UE can distinguish between the two by using a radio resource control (RRC) configuration of corsetPoolIndex to implicitly enable sDCI-mTRP-based 2TA operations or mDCI-mTRP-based 2 TA operations. For example, if the 2 TA configuration is configured for a serving cell and the RRC configuration of coresetPoolIndex for control resource sets is configured with more than one value for a BWP for different control resource sets, the UE determines to perform the mDCI-mTRP-based 2 TA operations—e.g., the multiple values of corsetPoolIndex indicate the mDCI-mTRP-based 2 TA operation are enabled and the UE performs the mDCI-mTRP-based 2 TA operations accordingly. In other embodiments, if the 2 TA configuration is configured for a serving cell and the RRC configuration of coresetPoolIndex for control resource sets is configured with no more than one value for a BWP for different control resource sets, the UE determines to perform the sDCI-mTRP-based 2 TA operations—e.g., the single value of corsetPoolIndex indicates the sDCI-mTRP-based 2 TA operation are enabled and the UE performs the sDCI-mTRP-based 2 TA operations accordingly.

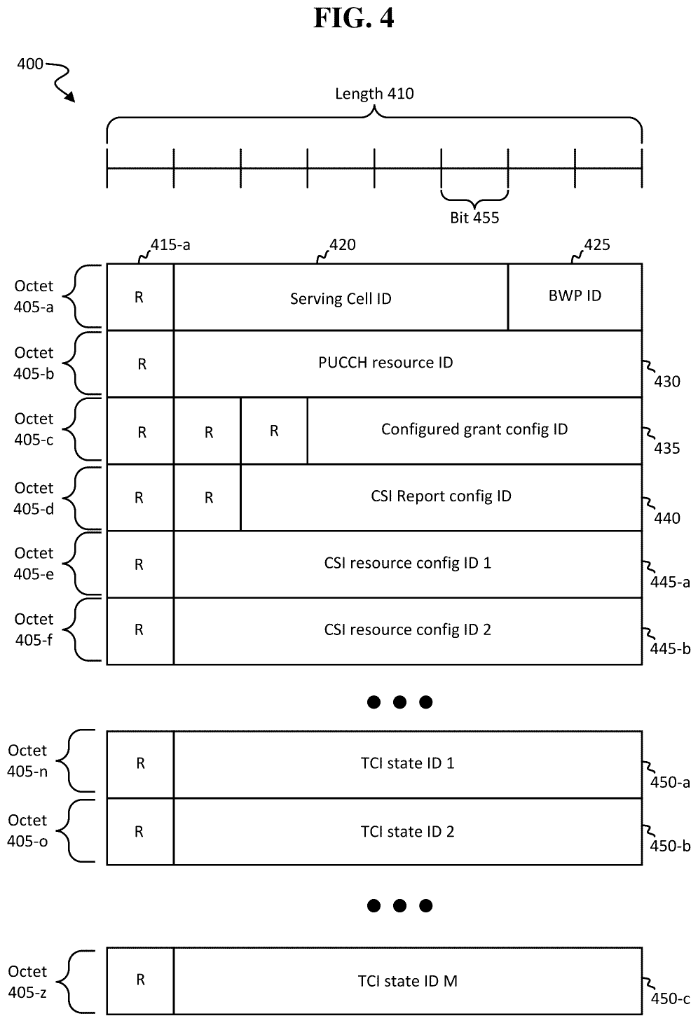

FIG. 4 illustrates an example single-entry MAC CE 400 for UE initiated CSI reports in accordance with an embodiment. In some embodiments a single-entry medium access control (MAC) control element (CE) is associated with a single serving cell. In some embodiments, the UE initiated CSI report is configured via the MAC CE 400. In at least one embodiment, the MAC CE 400 includes information for a single serving cell. In at least one embodiment, the MAC CE 400 includes a new logical channel identification (LCID) or a new extended LCID (eLCID) as illustrated in FIG. 4 and with respect to Tables 1 and 2 below.

For example, Table 1 illustrates LCID values for a downlink shared channel (DL-SCH) as follows:

TABLE 1

| Codepoint/ | |
|---|---|
| Index | LCID values |
| X1 | UE initiated beam reporting MAC CE with single entry |
| Y1 | UE initiated beam reporting MAC CE with multi-entry |

In some embodiments, Table 2 illustrates values of one octet 405 eLCID for DL-SCH as follows:

TABLE 2

| Codepoint | Index | LCID values |
|---|---|---|
| X2 | A1 | UE initiated beam reporting |
| | | MACE CE with single entry |
| Y2 | B1 | UE initiated beam reporting |
| | | MAC CE with multi-entry |

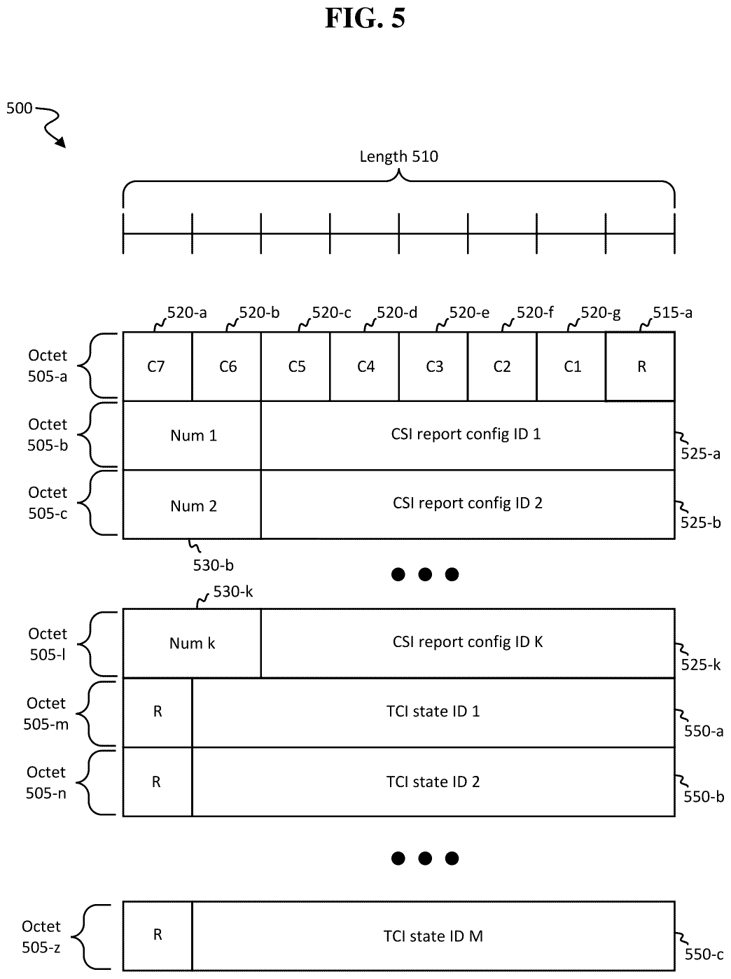

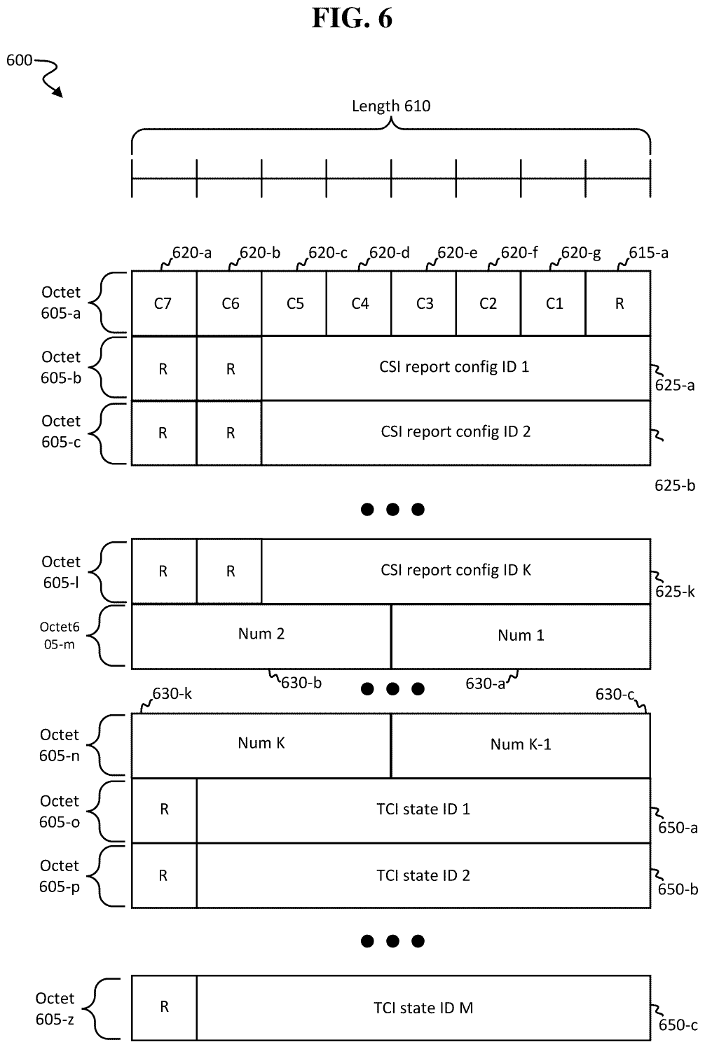

In at least one embodiment, the codepoint or index is utilized to identify either a single entry MAC CE for UE initiated beam reporting or a multi-entry MAC CE for UE initiated beam reporting. That is, the network can update resources for UE initiated beam reporting by transmitting a single entry MAC CE 400 or a multi-entry MAC CE (e.g., multi-entry MAC CE 500 or MAC CE 600 as described with reference to FIGS. 5 and 6). In one embodiment, if the UE (e.g., or MAC entity) receives a single-entry MAC CE 400 for UE initiated beam reporting, the UE can inform a lower layer (e.g., the physical layer) of the information included in the MACE CE 400. In some embodiments, the UE also applies the indicated resources for an indicated event associated with a bandwidth part (BWP) or serving cell for the UE initiated beam reporting.

For example, the MAC CE 400 can include one or more octets 405 each having a length 410. In one embodiment, the length 410 consists of eight (8) bits 455—e.g., each octet 405 can include eight (8) bits 455. In one embodiment, the MAC CE 400 can include a serving cell identification (ID) 420, a BWP identification (ID) 425, one or more event identifications (IDs), a physical uplink control channel (PUCCH) resource identification 430, a configured grant configuration identification 435, a CSI report configuration identification 440, one or more CSI resource identification (ID) 445, and one or more TCI state identification (IDs) 450.

In at least one embodiment, serving cell ID 420 indicates an identity of a serving cell for which the single-entry MAC CE 400 applies—e.g., identifies the serving cell associated with the UE initiated beam reporting. In one embodiment, a length of the serving cell ID 420 is five (5) bits.

In some embodiments, the BWP ID 425 indicates a downlink (DL) BWP associated with the MAC CE 400—e.g., indicates the DL BWP the MAC CE 400 applies as a codepoint for a DCI bandwidth part indicator field as specified in TS 38.212. In one embodiment, a length of the BWP ID 425 is two (2) bits.

In one embodiment, PUCCH resource ID 430 indicates resources (e.g., pre-configured resources) used for transmitting the UE initiated beam report notification. In one embodiment, the MAC CE 400 can include the configured grant configuration ID 435 (e.g., include configugredGrantConfigIndex or configuredGrantConfigIndexMAC) used for transmitting the UE initiated beam report content. In at least one embodiment, the PUCCH resource ID 430 indicates the resources used for transmitted UE initiated beam reporting notifications. For example, the single-entry MAC CE 400 can include the CSI report configuration ID 440 to indicate an event or the PUCCH resource ID 430 to indicate the PUCCH resources for the UE initiated beam reporting notifications or the physical uplink shared channel (PUSCH) resources (e.g., the configured grant indicated in the configured grant configuration ID 435) to indicate the PUSCH resources to transmit UE initiated beam reporting content.

In at least one embodiment, CSI report configuration ID 440 can include one or more event IDs. In one embodiment, the event ID indicates a UE initiated beam reporting event the single-entry MAC CE 400 is associated with. For example, the single-entry MAC CE 400 can include the CSI report configuration ID 440 and an event associated with the CSI report configuration ID 440 is applied for the UE initiated beam reporting—e.g., the event indicated in the CSI report configuration ID 440 is evaluated to determine whether a condition of the event if fulfilled as described with reference to FIG. 3.

In one or more embodiments, the CSI resource configuration identification 445 indicates a resource used for the UE initiated beam reporting measurements. That is, the CSI resource configuration identification 445 can indicate to use SSBs, CSI-RS, or other reference signals (RSs) for the measurement. As an example, CSI resource configuration ID 1 445-a can indicate a first resource to use and CSI resource configuration ID 2 445-b can indicate a second resource. For example, the first resource could be a first SSB or a first CSI-RS and the second resource could be a second SSB or a second CSI-RS. In at least one embodiment, the CSI resource configuration ID 445 can also include a current beam (e.g., a reference beam, a source beam, a reference signal (RS)) and/or new measured beams—e.g., indicate the new or target reference signals to measure for the event. For example, the MAC CE 400 can include the CSI report configuration 440 and the resources indicated in the CSI resource configuration IDs 445 are applied to measure a new/target beam or reference signal.

In one embodiment, a TCI state ID 450 indicates one or multiple joint TCI state or one or multiple DL TCI states indicating the current beam (e.g., the reference beam, source beam, or the reference signal) or the measured beams (e.g., the new target beam for the event). That is, the TCI state ID 450 can indicate the TCI state associated with the new or current beams.

In at least one embodiment, an octet 405 can include one or more remaining bits (R) 415.

It should be noted that a format of single-entry MAC CE 400 is shown for illustrative purposes only and is not limiting on the claims. The format of the single-entry MAC CE 400 can be different. In some embodiments, the single-entry MAC CE 400 can include any number of CSI resource configuration IDs 445 and any number of TCI state IDs 450. In one embodiment, an N^{th} octet 405 indicates a start of the TCI state IDs 450—e.g., octet 405-n. In such embodiments, the single-entry MAC CE 400 can include N. M number of octets 405—e.g., where M is the m^{th} TCI state ID 450-c.

FIG. 5 illustrates an example multi-entry MAC CE 500 for UE initiated CSI reports in accordance with an embodiment. In some embodiments a multi-entry medium access control (MAC) control element (CE) is associated with multiple serving cells. In some embodiments, the UE initiated CSI report is configured via the MAC CE 500. In at least one embodiment, the MAC CE 500 includes a new logical channel identification (LCID) or a new extended LCID (eLCID) as illustrated in FIG. 5 and with respect to Tables 1 and 2 above.

In one embodiment, the multi-entry MAC CE 500 can include a bitmap indicating a presence of information per a serving cell—e.g., the bitmap can indicate the serving cells in which the MAC CE 500 applies. In one embodiment, a single octet 505 bitmap is used when a highest serving cell index (e.g., ServCellIndex) of serving cells is less than eight (8). That is, as illustrated in FIG. 5, a single octet 505-a is used for the serving cell bitmap as the highest serving cell index is less than eight (8). In other embodiments, four octets 505 are used when the highest serving cell index of serving cells is greater than eight (8). If a bit 520 with an index i (e.g., denoted Cᵢ) is set to one (1), it indicates information for a serving cell with a serving cell index (e.g., ServCellIndex) i is present in the multi-entry MAC CE 500. In other embodiments, if the bit 520 with the index i is set to zero (0), it indicates information for the serving cell with the serving cell index (e.g., ServCellIndex) i is not present in the MAC CE 500—e.g., the information is absent. In at least some embodiments, the bitmap information can include information about the serving cell—e.g., the information for the serving cell can include a BWP ID, serving cell ID, one or more multiple event IDs, one or more PUCCH/PUSCH resource IDs indicating resources to use for reporting, one or more configured grant configuration IDs, one or more CSI resource IDs (e.g., SSB or CSI-RS) to use for the measurement, etc., as described with reference to FIG. 4.

In at least one embodiment, the MAC CE 500 includes one or more CSI report configuration IDs 525 and one or more TCI state IDs 550. In some embodiments, the CSI report configuration IDs 525 can include one or more event IDs. In at least one embodiment, the UE can perform measurements based on the event indicated by the CSI report configuration ID 525. In some examples, the TCI state ID 550 indicates one or multiple joint TCI state or one or multiple DL TCI states indicating the current beam (e.g., the reference beam, source beam, or the reference signal) or the measured beams (e.g., the new target beam for the event) as described with reference to FIG. 4.

In at least one embodiment, the multi-entry MAC CE 500 can include one or more number fields 530 (e.g., denoted Num). In some embodiments, the number field 530 indicates a number of TCI states for a measured beam (e.g., for a new or target beam or reference signal) for each serving cell presented in the MAC CE 500. That is, the number field 530 can indicate a number of octets 505 used for a respective TCI state ID 550 of each serving cell presented in the MAC CE 500. In one embodiment, as illustrated in FIG. 5, the number field 530 has a length of two bits for each serving cell. Accordingly, the number field 530 can indicate a one (1), two (2), three (3), or four (4). In at least one embodiment, a primary cell (Pcell) and serving cells for which a Cᵢ field is set to one (1), are indexed sequentially starting with the Pcell and followed by the other serving cells in ascending order of the serving cell index (ServCellIndex i). In some embodiments, an N number of octets 505 are used to indicate a number of TCI state for all the presented serving cells, if a total number of serving cells (e.g., serving cells present in the MAC CE 500, serving cells for which the field Cᵢ is set to one (1)) is greater than (2*(N−1)) and less than (2*(N+1)), where Nis one (1), two (2), three (3), or four (4) for a single octet Cᵢ field.

FIG. 6 illustrates an example multi-entry MAC CE 600 for UE initiated CSI reports in accordance with an embodiment. In some embodiments a multi-entry medium access control (MAC) control element (CE) is associated with multiple serving cells. In some embodiments, the UE initiated CSI report is configured via the MAC CE 600. In at least one embodiment, the MAC CE 600 includes a new logical channel identification (LCID) or a new extended LCID (eLCID) as illustrated in FIG. 6 and with respect to Tables 1 and 2 above. In at least one embodiment, a format of multi-entry MAC CE 600 is similar to a format of multi-entry MAC CE 500 as described with reference to FIG. 5. That is, the MAC CE 600 can include the bitmap, a BWP ID, serving cell ID, one or more multiple event IDs, one or more PUCCH/PUSCH resource IDs indicating resources to use for reporting, one or more configured grant configuration IDs, one or more CSI resource IDs (e.g., SSB or CSI-RS) to use for the measurement, etc., as described with reference to FIG. 5.

In at least one embodiment, though, a number field 630 in the MAC CE 600 can include four (4) bits for each serving cell. Accordingly, the number field 630 in the MAC CE 600 can indicate a one (1), two (2), three (3), . . . , fifteen (15), or sixteen (16). In some embodiments, because each number field 630 includes four bits, the number fields 630 can be transmitted in octets 605 after the CSI report configuration IDs 625 are transmitted. For example, the last CSI report configuration ID K 625-k can be included in an octet 605-1 (e.g., an octet that is K+1). In such embodiments, the number fields 630 can range from octet 605-m (e.g., K+2) to octet 605-n (e.g., K+N+1).

In at least one embodiment, a primary cell (Pcell) and serving cells for which a Cᵢ field is set to one (1), are indexed sequentially starting with the Pcell and followed by the other serving cells in ascending order of the serving cell index (ServCellIndex i). In some embodiments, an N number of octets 505 are used to indicate a number of TCI state for all the presented serving cells, if a total number of serving cells (e.g., serving cells present in the MAC CE 600, serving cells for which the field Cᵢ is set to one (1)) is greater than (2*(N−1)) and less than (2*(N+1)), where Nis one (1), two (2), three (3), or four (4), . . . fifteen (15), or sixteen (16) for a four-octet Cᵢ field.

In some embodiments, some octets 605 can include one or more remaining bits (R) 615.

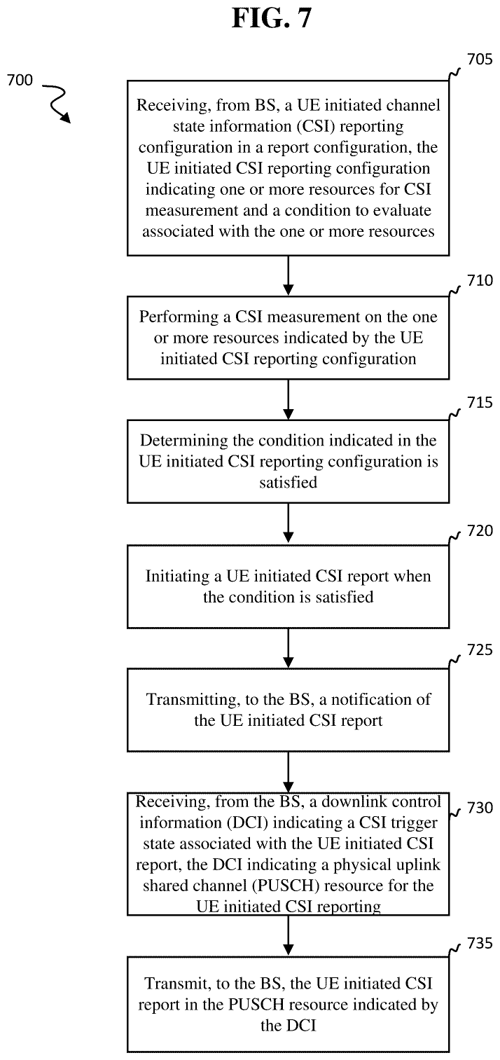

FIG. 7 shows an example process 700 for UE initiated CSI reporting in accordance with an embodiment. For explanatory and illustration purposes, the example process 700 may be performed by an UE (e.g., UE 111-116 as described with reference to FIG. 1). In some embodiments, a processor or transceiver of the UE can perform the operations described herein. Although one or more operations are described or shown in particular sequential order, in other embodiments the operations may be rearranged in a different order, which may include performance of multiple operations in at least partially overlapping time periods.

Referring to FIG. 7, the process 700 may begin at operation 705. At operation 705, the UE can receive, from a base station (BS), a UE initiated channel state information (CSI) reporting configuration in a report configuration type field, the UE initiated CSI reporting configuration including one or more resources for CSI measurements and a condition to evaluate associated with the one or more resources. That is, as described with reference to FIG. 3, the UE can receive the UE initiated CSI reporting configuration from the BS (e.g., network or gNB), where the UE initiated CSI reporting is per bandwidth part (BWP) or per serving cell. In at least one embodiment, the UE initiated CSI reporting involves including a new type “UE initiated/event triggered” parameter in report configuration field—e.g., the CSI-ReportConfig can include a reportConfigType field including the UE initiated/event triggered parameter. In some embodiments, the UE initiated CSI reporting configuration can be transmitted as part of UE initiated CSI report operation—e.g., as part of a UE initiated/event driven beam reporting or UE initiated/event triggering. In at least one embodiment, the UE initiated CSI reporting configuration can include one or more event identifications (IDs), the one or more event IDs can indicate one or more events. In such embodiments, the events are characterized by the event ID, associated reporting quantities, and parameters. For example, the UE initiated CSI reporting configuration includes (e.g., or associated with) one or more parameters for the condition, the parameters including one or more thresholds for a reference signal received power (RSRP), reference signal received quality (RSRQ), or a signal-to-noise-plus-interference-ratio (SINR). As an example, the event can be a new or measured reference signal (RS) being better than a current RS by a RSRP threshold amount. In at least one embodiment, the current RS can be an RS associated with a current transmission configuration indication (TCI) state for a last physical uplink control channel (PUCCH) or physical uplink shared channel (PUSCH) transmission. In other embodiments, the current RS can be an RS indicated in a received message from the BS—e.g., in a received radio resource control (RRC) message, a medium access control (MAC) control element (CE), or downlink control information (DCI). In some embodiments, each resource of the one or more resources for the CSI measurements is identified by a respective CSI resource ID. In at least one embodiment, the CSI resource IDs indicate a current beam (e.g., the reference or source beam/RS) and/or beams to measure (e.g., the new/target beam) for an event.

In at least one embodiment, the UE initiated CSI reporting configuration includes a report quantity (e.g., associated report quantities) indicating quantity to measure or report for the UE initiated CSI report. That is, depending on a bandwidth of the network or based on qualities the network wants to determine, the network can ask for more or less information in the CSI report. For example, the network can indicate how many beams the UE should measure and how many beams the UE should report on. In some embodiments, the number of beams is based on the event condition—e.g., any beam satisfying the event condition is reported. In other embodiments, the number of beam is indicated by the network—e.g., the network indicates the number of beams, regardless of whether the beam satisfies the condition. In other embodiments, the report quantity indicates a type of report result (e.g., RSRP or SINR) to measure or report for the UE initiated CSI report. In some embodiments, the event ID can be indicated in MAC CE or in DCI. In some embodiments, the one or more resources for the CSI measurements indicate one or more reference signals to measure. For example, the one or more reference signals to measure can include a synchronization signal block (SSB) signal or a CSI-reference signal (RS). That is, the UE initiated CSI reporting configuration indicates which resources to use for the CSI measurements. In some embodiments, the UE can use a combination of SSBs and CSI-RSs. In at least one embodiment, the one or more resources for reporting CSI includes a physical uplink control channel (PUCCH) resource identification (ID) to identify one or more PUCCH resources to use to transmit the report notification. In one embodiment, the one or more resources for reporting the CSI measurements includes a PUSCH resource identification (ID) to identify one or more PUSCH resources to use to transmit the UE initiated CSI report—e.g., when a second mode is enabled for the UE. That is, the UE initiated CSI reporting configuration can include one or more resources for CSI measurements (e.g., a first set of resources) and include one or more resources for CSI reporting e.g., a second set of resources).

For example, the UE initiated reporting configuration can include a report type indicating a mode for reporting the UE initiated CSI report. In one embodiment, a first mode for the report type can indicate the UE waits to transmit the CSI report until the BS provides a dynamic grant. In other embodiments, a second mode for the report type can indicate the PUSCH resources to transmit the CSI report on and the UE can transmit the CSI report on the PUSCH resources indicated after determining the event condition is satisfied. In at least one embodiment, the PUSCH resource identification (ID) to identify one or more PUSCH resources to use to transmit the UE initiated CSI report are included for the second mode only. In one embodiment, the PUCCH/PUSCH resource ID (e.g., PUCCH-ResourceId, configuredGrantConfigIndex, or configuredGrantConfigIndexMAC as described with reference to FIG. 3) can indicate resources uses for transmitting UE initiated beam reporting content. For example, the PUCCH or PUSCH resources indicated in the CSI-ReportConfigId are applied for transmitted the UE indicated beam reporting notification and/or report content. In at least one embodiment, the UE initiated CSI reporting configuration can include one or more TCI state identifications (ID). In such embodiments, the TCI state IDs refer to one or more multiple joint TCI state or one or multiple downlink (DL) TCI states. In some embodiments, the TCI state IDs indicate the current beam or the measured beam for the event.

At operation 710, the UE can perform a CSI measurement on the one or more resources indicated by the UE initiated CSI reporting configuration. That is, the UE can evaluate the condition of an event ID of the one or more event IDs using the one or more resources based on receiving the CSI reporting configuration. For example, the UE measures the indicated one or more resources for CSI measurements (e.g., SSB or CSI-RS) and evaluates the condition associated with the event based on the measurements. As an example, the UE could measure the current beam and the new beam using the one or more resources indicated.

At operation 715, the UE can determine the condition indicated in the UE initiated CSI reporting configuration is satisfied. For example, the UE can determine the new beam is better than the current beam by a threshold amount.

At operation 720, the UE can initiate a UE initiated CSI report when the condition is satisfied.

At operation 725, the UE can transmit, to the BS, a notification of the UE initiated CSI report. In some embodiments, the UE can transmit the notification to the BS on one or more resources for reporting the CSI measurements (e.g., on one or more resources indicated in the second set of resources). That is, the UE can determine the condition is satisfied (e.g., that a new RS is better than current RS by a RSRP threshold amount) and transmit the notification on one or more PUCCH resources indicated in the PUCCH resource ID.

At operation 730, the UE can receive, from the BS, a downlink control information (DCI) indicating a CSI trigger state associated with the UE initiated CSI report, the DCI indicating a physical uplink shared channel (PUSCH) resource for the UE initiated CSI reporting. In some embodiment, the DCI received has a format associated with scheduling physical uplink shared channel (PUSCH), based on transmitting the notification. That is, the DCI can have a format 0_1 or a format 0_2, associated with scheduling the PUSCH resources. In at least one embodiment, the received DCI can be associated with UE initiated CSI reporting. That is, the BS and UE can use a CSI request field in the DCI format 0_1 or 0_2 to trigger the transmission of the UE initiated CSI report. As an example, the DCI can include a codepoint in a DCI field CSI request. In such examples, if the codepoint indicates one CSI trigger state for a CSI report on RS(s) configured to be used for the UE initiated beam reporting, the UE can measure the RSs and apply the associated CSI report configuration indicated in the DCI. In some embodiments, the UE can determine the CSI trigger state associated with UE initiated CI reporting indicated in a CSI request field of the DCI. That is, the UE can determine the DCI format 0_1/0_2 includes a CSI request field with the CSI trigger state associated with UE initiated beam reporting.

At operation 735, the UE can transmit, to the BS, the UE initiated CSI report in the PUSCH resource indicated by the DCI. In at least one embodiment, the UE can transmit the notification as a one-bit flag in a uplink control information (UCI) or by sending a scheduling request (SR). In at least one embodiment, the UE transmits the UE initiated CSI report as UCI in a dynamic grant indicated in the received DCI.

In at least one embodiment, the UE can determine if a medium access control (MAC) entity associated with the UE monitors a physical downlink control channel (PDCCH) of a serving cell belonging to a discontinuous reception (DRX) group. In such embodiments, the UE can transmit the UE initiated CSI report when the UE initiated CSI report is initiated whether the MAC entity monitors the PDCCH or the MAC entity refrains from monitoring the PDCCH. That is, irrespective of whether the MAC entity is monitoring PDCCH or not in the serving cells of the DRX group, the UE can transmit the UE initiated CSI report as initiated or expected—e.g., even when PDCCH is not being monitored, the UE can still transmit the UE initiated CSI report as indicated in the DCI.

In at least one embodiment, a base station can include a transceiver. In such embodiments, the BS can transmit, to a UE, a UE initiated channel state information (CSI) reporting configuration, the UE initiated CSI reporting configuration indicating one or more resources for CSI measurement and a condition to evaluate associated with the one or more resource. That is, the BS can initiate the UE initiated beam reporting, indicate events or conditions the UE should measure, and indicate resources for performing and reporting the CSI measurements. In some embodiments, the BS can indicate a first mode or a second mode in the UE initiated CSI reporting configuration—e.g., the BS can indicate whether the UE is to wait for the BS to schedule the CSI report in a DCI or if the UE is to transmit the UE initiated CSI report in a preconfigured resource. In some embodiments, the BS can further receive, from the UE, a notification of the UE initiated CSI report—e.g., when the UE determines the condition is satisfied, the BS can receive the notification. In at least one embodiment, the BS can transmit, to the UE, a downlink control information (DCI) indicating a CSI trigger state associated with the UE initiated CSI report, the DCI indicating a physical uplink shared channel (PUSCH) for the UE initiated CSI reporting. That is, the BS can indicate which PUSCH resource to utilize for reporting the UE initiated CSI report. In some embodiments, the BS can receive, from the UE, the UE initiated CSI report in the PUSCH resource indicated by the DCI. In that, the BS can schedule and receive the CSI report based on transmitting the DCI. In some embodiments, the UE initiated CSI reporting configuration transmitted by the BS includes one or more parameters for the condition, the parameters including one or more thresholds for reference signal received power (RSRP), reference signal received quality (RSRQ), or a signal-to-interference-plus-noise-ratio (SINR). In some embodiments, the one or more resources for the CSI measurement in the CSI report configuration transmitted by the BS include one or more reference signals, the one or more reference signals including a synchronization signal block (SSB) signal or a CSI-reference signal (RS).

In some embodiments, the UE is to evaluate the condition of an event ID of the one or more event IDs using the one or more resources for the CSI measurements. In some cases, the UE can also determine the condition of the event ID is satisfied, where the determining the condition of the CSI measurement is satisfied is based on determining the condition of the event ID is satisfied.

Various embodiments in the disclosure provides a mechanism for a UE initiated CSI reporting to be triggered via a DCI CSI trigger state, reducing network overhead.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) for facilitating communication in a wireless network, the UE comprising:
a transceiver configured to cause;
receive, from a base station (BS), a UE initiated channel state information (CSI) reporting configuration, the UE initiated CSI reporting configuration indicating one or more resources for CSI measurement and a condition to evaluate associated with the one or more resources; and
a processor operably coupled to the transceiver, the processor configured to cause:
perform a CSI measurement on the one or more resources indicated by the UE initiated CSI reporting configuration;
determine the condition indicated in the UE initiated CSI reporting configuration is satisfied; and
initiate a UE initiated CSI report when the condition is satisfied,
wherein the transceiver is further configured to cause:
transmit, to the BS, a notification of the UE initiated CSI report;
receive, from the BS, a downlink control information (DCI) indicating a CSI trigger state associated with the UE initiated CSI report, the DCI indicating a physical uplink shared channel (PUSCH) resource for the UE initiated CSI reporting; and
transmit, to the BS, the UE initiated CSI report in the PUSCH resource indicated by the DCI.

2. The UE of claim 1, wherein the processor is further configured to cause:
determine if a medium access control (MAC) entity associated with the UE monitors a physical downlink control channel (PDCCH) of a serving cell belonging to a discontinuous reception (DRX) group; and
wherein the transceiver is further configured to:
transmit the UE initiated CSI report when the UE initiated CSI report is initiated whether the MAC entity monitors the PDCCH or the MAC entity refrains from monitoring the PDCCH.

3. The UE of claim 1, wherein the UE initiated CSI reporting configuration includes a report type indicating a mode of the UE initiated CSI report.

4. The UE of claim 1, wherein each of the one or more resources for the CSI measurements is identified by a respective CSI resource ID.

5. The UE of claim 1, wherein the one or more resources for the CSI measurements indicate one or more reference signals, the one or more reference signals including a synchronization signal block (SSB) signal or a CSI-reference signal (RS).

6. The UE of claim 1, wherein the UE initiated CSI reporting configuration includes one or more resources for CSI reporting including a physical uplink control channel (PUCCH) resource identification (ID) to identify one or more PUCCH resources to use to transmit the notification.

7. The UE of claim 1, wherein the UE initiated CSI reporting configuration includes one or more resources for CSI reporting including a PUSCH resource identification (ID) to identify one or more PUSCH resources to use to transmit the UE initiated CSI report.

8. The UE of claim 1, wherein the UE initiated CSI reporting configuration includes a report quantity indicating a quantity to measure or report for the UE initiated CSI report.

9. The UE of claim 1, wherein the UE initiated CSI reporting configuration includes one or more parameters for the condition, the parameters including one or more thresholds for reference signal received power (RSRP), reference signal received quality (RSRQ), or a signal-to-interference-plus-noise-ratio (SINR).

10. The UE of claim 1, wherein the UE initiated CSI reporting configuration includes one or more event identifications (IDs), and wherein the processor is further configured to cause:
evaluate the condition of an event ID of the one or more event IDs using the one or more resources for the CSI measurement; and
determine the condition of the event ID is satisfied, wherein the determining the condition of the CSI measurement is satisfied is based on determining the condition of the event ID is satisfied.

11. A method performed by a user equipment (UE) for facilitating communication in a wireless network, comprising:
receiving, from a base station (BS), a UE initiated channel state information (CSI) reporting configuration, the UE initiated CSI reporting configuration indicating one or more resources for CSI measurement and a condition to evaluate associated with the one or more resources;
performing a CSI measurement on the one or more resources indicated by the UE initiated CSI reporting configuration;
determining the condition indicated in the UE initiated CSI reporting configuration is satisfied;
initiating a UE initiated CSI report when the condition is satisfied;
transmitting, to the BS, a notification of the UE initiated CSI report;
receiving, from the BS, a downlink control information (DCI) indicating a CSI trigger state associated with the UE initiated CSI report, the DCI indicating a physical uplink shared channel (PUSCH) resource for the UE initiated CSI reporting; and
transmitting, to the BS, the UE initiated CSI report in the PUSCH resource indicated by the DCI.

12. The method of claim 11, further comprising:
determining if a medium access control (MAC) entity associated with the UE monitors a physical downlink control channel (PDCCH) of a serving cell belonging to a discontinuous reception (DRX) group; and
transmitting the UE initiated CSI report when the UE initiated CSI report is initiated whether the MAC entity monitors the PDCCH or the MAC entity refrains from monitoring the PDCCH.

13. The method of claim 11, wherein the UE initiated CSI reporting configuration includes a report type indicating a mode of the UE initiated CSI report.

14. The method of claim 11, wherein each of the one or more resources for the CSI measurements is identified by a respective CSI resource ID.

15. The method of claim 11, wherein the one or more resources for the CSI measurements indicate one or more reference signals, the one or more reference signals including a synchronization signal block (SSB) signal or a CSI-reference signal (RS).

16. The method of claim 11, wherein the UE initiated CSI reporting configuration includes one or more resources for CSI reporting including a PUSCH resource identification (ID) to identify one or more PUSCH resources to use to transmit the UE initiated CSI report.

17. The method of claim 11, wherein the UE initiated CSI reporting configuration includes one or more parameters for the condition, the parameters including one or more thresholds for reference signal received power (RSRP), reference signal received quality (RSRQ), or a signal-to-interference-plus-noise-ratio (SINR).

18. A base station (BS) for facilitating communication in a wireless network the BS comprising:
a transceiver configured to cause:
transmit, to a user equipment (UE), a UE initiated channel state information (CSI) reporting configuration, the UE initiated CSI reporting configuration indicating one or more resources for CSI measurement and a condition to evaluate associated with the one or more resource;
receive, from the UE, a notification of a UE initiated CSI report;
transmit, to the UE, a downlink control information (DCI) indicating a CSI trigger state associated with the UE initiated CSI report, the DCI indicating a physical uplink shared channel (PUSCH) resource for the UE initiated CSI reporting; and
receive, from the UE, the UE initiated CSI report in the PUSCH resource indicated by the DCI.

19. The BS of claim 18, wherein the UE initiated CSI reporting configuration includes one or more parameters for the condition, the parameters including one or more thresholds for reference signal received power (RSRP), reference signal received quality (RSRQ), or a signal-to-interference-plus-noise-ratio (SINR).

20. The BS of claim 18, wherein the one or more resources for the CSI measurements indicate one or more reference signals, the one or more reference signals including a synchronization signal block (SSB) signal or a CSI-reference signal (RS).
